(19) United States
(12) Patent Application Publication
(10) Pub. No.: US 2017/0212023 A1
(43) Pub. Date: Jul. 27, 2017

(54) METHOD AND APPARATUS FOR A HARDNESS TEST BLOCK

(71) Applicants: Giancarlo Mazzoleni, Philadelphia, PA (US); Carlo Mazzoleni, Philadelphia, PA (US)

(72) Inventors: Giancarlo Mazzoleni, Philadelphia, PA (US); Carlo Mazzoleni, Philadelphia, PA (US)

(21) Appl. No.: 15/407,559

(22) Filed: Jan. 17, 2017

Related U.S. Application Data
(60) Provisional application No. 62/279,813, filed on Jan. 17, 2016.

(51) Int. Cl. G01N 3/42; G01B 11/28; G01N 3/40; G01B 11/02

(52) U.S. Cl. CPC G01N 3/42; G01B 11/022; G01B 11/285; G01N 3/40; G01N 2203/008

(57) ABSTRACT

A hardness test block wherein the number of test sites is optimized for a given test block size and a hardness being tested. The hardness test block has an alignment template that enables an operator to be assured of having the test bock grid pattern aligned properly with the indenter of a hardness testing machine. Another means for aligning the test block with the hardness testing apparatus is a cradle for the test block so that the primary test surface as well as the opposite surface can both be used for testing purposes such that the cradle protects the test surface from being contacted by the anvil of the hardness testing machine during the test operation. Another alternative is having a plurality of legs or pins on the test surface of the test block to prevent the test surface from contacting the anvil when the opposite test surface is being used for testing. A formula is provided so that the optimum grid pattern for a test surface can be obtained for any test block, irrespective of size, shape, or expected indentation size in order to obtain the least amount of test block material needed for a given number of test sites.

This application claims benefit of U.S. Provisional Application Ser. No. 62/279,813 filed Jan. 17, 2016 pursuant to 25 USC §119(e).

### FIELD OF THE INVENTION

This invention relates to hardness testing equipment and methods, in particular, test blocks for checking the accuracy of the hardness measuring equipment.

### BACKGROUND OF THE INVENTION

Indentation testing is very widely used in the industry for the determination of metal hardness. Hardness is a characteristic of a material, not a fundamental physical property. It is defined as the resistance to indentation, and it is determined by measuring the permanent depth of the indentation or its diameter. That is, when using a fixed force (load) on a particular indenter, the smaller the indentation, the harder the material. Indentation hardness value is obtained by measuring the depth or the area of the indentation using one of over 12 different test methods.

One of the most common methods of determining hardness is the Brinell hardness test method as defined in ASTM E10. Typically, it is used to test materials having a structure that is too coarse or that have a surface that is too rough to be tested using another test methods. Brinell testing often uses a very high test load (3000 kgf) and a 10 mm diameter indenter so that the resulting indentation averages out most surface and sub-surface inconsistencies.

The Brinell method applies a predetermined test load (F) to a hard steel or carbide ball of fixed diameter (D), which is held for a predetermined time period and then, removed. The resulting impression is measured across at least two diameters—usually at right angles to each other and the result is averaged. A chart is then used to convert the averaged diameter measurement to a Brinell hardness number. Test forces range from 500 to 3000 kgf.

A Brinell hardness result measures the permanent diameter of the indentation produced by a hard steel or carbide indenter applied to a test specimen at a given load, for a given length of time. Typically, an indentation is made with a Brinell hardness testing machine and then measured for indentation diameter in a second step with a specially designed Brinell microscope. The resulting measurement is converted to a Brinell value using the Brinell formula or a conversion chart based on the formula.

Most typically, a Brinell test will use 3000 kgf load with a 10 mm ball. If the sample material is aluminum, the test is most frequently performed with a 500 kgf load and a 10 mm ball. Brinell test loads can range from 3000 kgf down to 1 kgf. Diameters of the indenter ball can range from 10 mm to 1 mm. Generally, the lower loads and ball diameters are used for convenience in “combination” testers, like Rockwell units, that have a small load capacity. The test standard specifies a time of 10 to 15 seconds, although shorter times can be used if it is known that the shorter time does not affect the result. There are other conditions that must be met for testing on a round specimen, such as spacing of indentations, minimum thickness of test specimens, etc.

Common to all of these hardness testing methods and hardness testing equipment is the use of testing blocks, such as Rockwell, Brinell, Vickers and Knoop. These test blocks come in different sizes and materials depending on the hardness of the material and surface configurations of the material that is to be tested. The material that makes up these test blocks must be uniform throughout in order to meet the strict repeatability requirements of the ASTM standards. Therefore, the cost of the material per indentation allowed is a large component of the total cost of producing these test blocks. Further, the larger the indentation for each test performed, the lower the number of tests that can be done on a particular sized block. The expected indentation size corresponds to the hardness of the material of the test block . . . harder material yields smaller indentations. The indentation sizes for 3000 Kg test force and a 10 mm diameter indenter ranges from 2.4 to 6.0 mm.

For example, a large area of test block is unusable due to the spacing requirement as found with a typical 2.5 inch by 6 inch (63.5 mm by 152.4 mm) Brinell block of 302 BHN value and having a 3.5 mm diameter indentation. This block using prior art layouts methods of test sites can only accommodate 65 test sites per block.

These standardized test blocks are used to verify that the testing equipment, test methods and operator is performing within the required parameters.

There are several issues with the current test blocks being offered. As noted above, the number of test sites per block is limited due to the spacing requirements. While test blocks are typically laid out with a grid pattern to indicate the proper spacing and location of the test sites, an operator who fails to properly line up with the test block with the hardness testing machine even by a small amount, the spacing between subsequent tests cannot be maintained and even less tests can be utilized.

Frequently, in aerospace operations as well as other critical performance situations, it is often vital to be able to re-measure one or more of the indentations to verify the results. This is difficult when using current methods.

Finally, there is no method for optimizing the test sites patterns on a given size test block for a particular indentation size (corresponding to a particular hardness). With the current grid imprinting available on some test blocks, it is still possible to place indentation inside the marked area and still not meet the spacing requirements.

### SUMMARY OF THE INVENTION

It is an aspect of the invention to provide a hardness test block wherein the number of test sites is optimized for a given test block size and a hardness being tested.

It is another aspect of the invention to provide a hardness test block having an alignment template that enables an operator to be assured of having the test bock grid pattern aligned properly with the indenter of a hardness testing machine.

Another aspect of the invention is to provide a cradle for a test block so that the primary test surface as well as the opposite surface can both be used for testing purposes such that the cradle protects the test surface from being contacted by the anvil of the hardness testing machine during the test operation.

Still another aspect of the invention is to provide a test block having a plurality of legs or pins on the test surface of the test block to prevent the test surface from contacting the anvil when the opposite test surface is being used for testing.

Finally, it is an aspect of the invention to provide a formula so that the optimum grid pattern for a test surface can be obtained for any test block, irrespective of size, shape, or expected indentation size in order to obtain the least amount of test block material needed for a given number of test sites.

### BRIEF DESCRIPTION OF THE DRAWINGS

FIG. 1 is a representative Brinell 2.5 inch by 6 inch (63.5 mm by 152.4 mm) test block showing the grid pattern of 65 test sites, with each site accommodating a 3.5 mm expected diameter indentation and meeting ASTM spacing requirements.

FIG. 2 is a top or bottom view of the test block shown in FIG. 1 with the improvement of the plurality of legs (pins) installed to permit a doubling of the number of test sites for a given test block configuration and as an alignment means.

FIG. 3 is an isometric view of the cradle improvement, which permits the use of a second testing surface opposite to the primary top testing surface of the test block.

FIG. 4 is an isometric view of the alignment template with the spacing indicia affixed thereon.

FIG. 5 is an illustration of a typical test block showing the locations of the measurements used to calculate the layout of the indentation test sites.

FIG. 6 is an illustration of an improved test block showing the locations of the measurements used to calculate the layout of the indentation test sites that provides a 29% increase in indentation test sites with only an 11% increase in test block surface area.

### DETAILED DESCRIPTION OF THE INVENTION

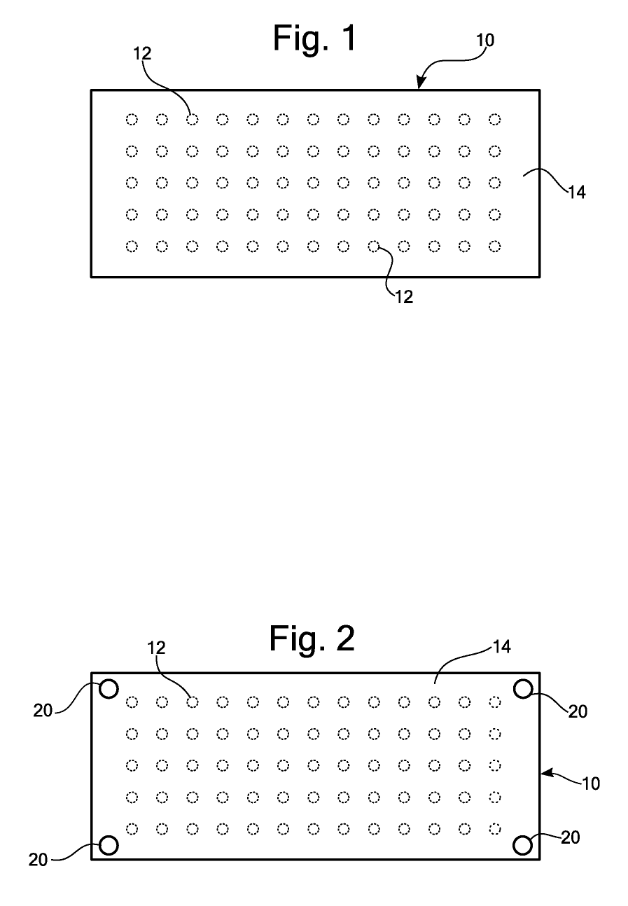

Shown in FIG. 1, is a typical Brinell 2.5 inch by 6 inch test block 10 showing the grid pattern of 65 test sites 12, with each site accommodating a 3.5 mm expected diameter indentation and meeting ASTM spacing requirements. Note that this layout does not use the staggered method of laying out test sites using a staggered technique that can provide a greater number of test sites for the same sized test block. (See U.S. Pat. No. 3,352,148, issued to Johnson on Nov. 14, 1967.) However, the techniques and methods described herein can also be applied to test blocks having a staggered pattern as disclosed by Johnson.

All of test sites 12 are provided on surface 14. The layout of sites 12 can be shown inscribed on surface 14 by being imprinted or etched on surface 14 or surface 14 can be left blank. However, due to the ASTM spacing requirements, the number of test sites is limited irrespective of whether surface 14 is marked with the location of the test sites or left blank. Also, notice that only surface 14 is finished and is useable for testing since the opposite surface rests on the anvil and would be marred by the contact with the anvil of the tester apparatus.

While only 2.5 inch by 6 inch (63.5 mm by 152.4 mm) rectangular test blocks is shown in the accompanying figures, the principles and methods discussed herein are applicable for any size test blocks, irrespective of whether the blocks are rectangular, square, or round. Those who are skilled in the art will be able to scale the ideas presented herein to any particular test block of choice.

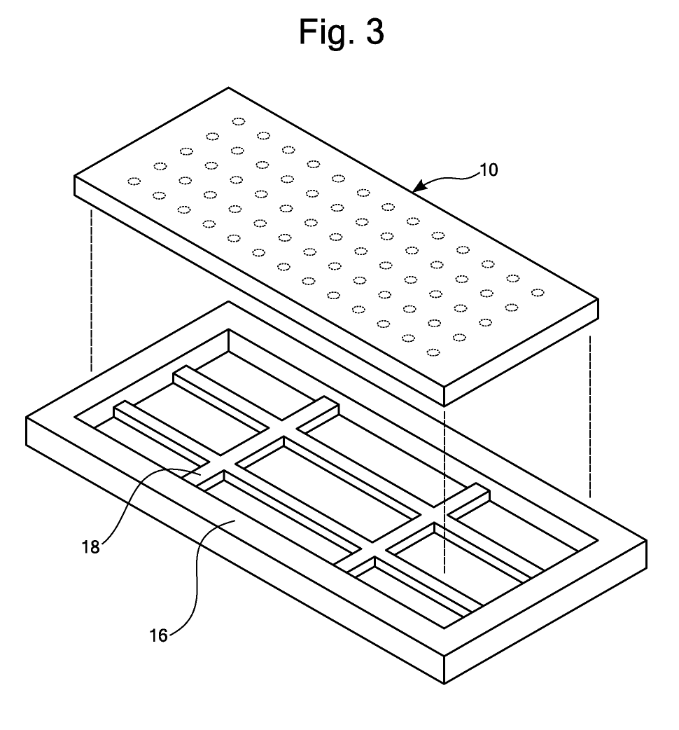

Referring now to FIG. 2, an improvement to double the number of test sites for a particular test block is disclosed. By the addition of legs (pins) 20 to surface 14 as well as legs (pins) 20 to both the top and bottom surfaces 14 as shown in FIG. 2, twice the number of test sites is available for the same amount of test block material, yet the required spacing is still maintained. Legs 20 prevent the test surfaces 14 and 22 of test block 10 from contacting the anvil of hardness tester (not shown). Legs 20 can be pins that press fit into holes on the testing surfaces 14, 22 of test block 10. Also, legs 20 provide means for aligning test block 10 so that proper indexing of test block 10 from one test site to another test site without overlapping or causing a waste of testing material. Other suitable methods of raising the test surfaces 12, 22 from the anvil during testing operations could also be used, such as gluing or otherwise attaching a plurality of standoffs to that surface. The height necessary for raising testing surfaces 12, 22 is only about 1/32 inch. The drawings indicate a greater length for illustrative purposes. While the number of pins 20 is shown to be 6, this number can be more or less depending on the configuration of the test block as well as the expected loads that will be experienced by the test block.

As an alternative to pins 20, cradle 16 is shown in FIG. 3. In this embodiment, cradle 16 is provided to hold test block 10 while it is undergoing testing operation. Cross members 18 hold the test surface away from the anvil while the opposite surface is being used. While three cross members 18 are shown, more or less could be used, again depending on the configuration of test block 10 and the expected forces that will be applied to test block 10. Cradle 16 would also be round when used with round test blocks.

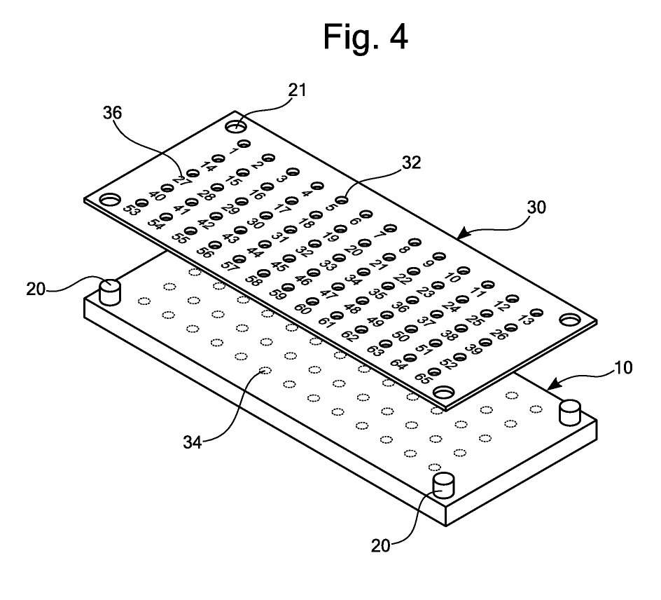

Alignment template 30, which provides means for alignment of test block 10 is shown in FIG. 4. Template 30 is preferably a plastic plate that is dimensioned in accordance with test block 10 that it is being mated with. The pins of the test block are used to position template 30, or in the case of a test block without pins 20, a single pinhole 21 can be placed in one corner of the test bock 10, with one pin 20 placed in test block 10, thus allowing template 30 to be rotated out of the way after locating the test point.

Template 30 is preferably transparent so that the indicia, in any, on test block 10 can be visualized. Holes 34 are provided in template 30 that are laid out in accordance with spacing requirements and correspond to the centers of indentations that are to be made in test block 10. Additional indicia can also be provided such as the size of the indentations expected 32 or the numbering or other identification of each test site 36. This is especially useful to identify a particular test during the current verification of the test machine. It also makes it helpful to re-measure an indentation as in Brinell testing. This in combination with reporting of the test location and in addition to the result of the test increases the traceability of the verification. This is critically important in the aerospace industry as well as other situations where such accuracy is critical.

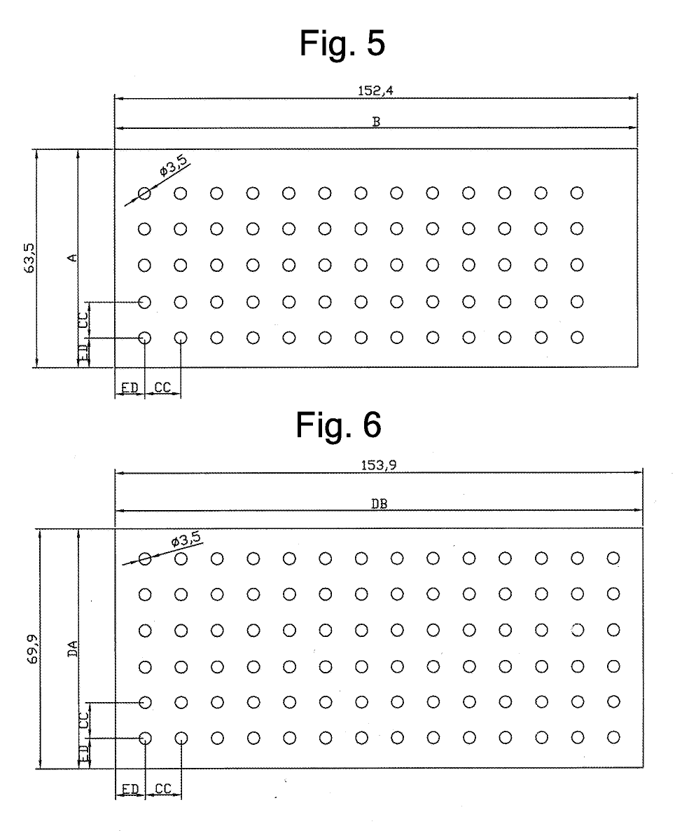

As noted above, a critical feature of the invention is to provide a method of calculating the optimum size test block for any particular hardness level. As previously stated, a hardness level corresponds to a particular expected indentation diameter. Referring now to FIGS. 5, 6 in concert with the following equations will show how this process is accomplished. While only one example is provided, the procedure can easily be scaled by those of ordinary skill in the art to meet the requirements for all test block situations. As shown in FIG. 5, a typical test block is depicted. In this example, the test block, A is 2.5 inches (63.5 mm) and B is 6 inches (152.4 mm). ED is distance from the center of the indentation to the edge of the block. CC is the center to center indentation. ED and CC are requirements of ASTM and ISO standards (ED equals 2.5 times the diameter of the indentation and CC equals 3 times the diameter of the indentation).

In the example, CC is 3 times the indentation diameter from the center of indentation to the center of an adjacent center of indentation. NIS is the number of possible indentations on a standard block. NN is NIS+1. Number of 3.5 mm possible indentations along the short dimension A is 5 which is the integer plus 1 of (A−(2 times ED)) divided by CC or 63.5−(2 times 8.7) divided by 10.5, which equals 5 or NIS. NN is 6.

If we wanted to add one more row of indentations, that is, 6, what would the length of A? Call this length DA as shown in FIG. 6. This is provided by (2 times ED)+(CC times NN−1). In other words, (2 times 8.7)+(10.5 times 5) equals 69.9 mm. Thus, DA is 69.9 mm.

To calculate the number of test sites of 3.5 mm along the long dimension of the test block shown in FIG. 5, calculate as follows: NIS of B equals integer plus 1 of (B−(2 times ED)) divided by CC or 152.4−(2 times 8.7))/10.5 which equals 13.

As before, to add one more row, NN of B is 14. To calculate the length of DB shown in FIG. 6, (2 times ED)+(CC times NN−1) which, by substituting the values of the variables yields, (2 times 8.7)+(10.5 times 13) resulting in 153.9 mm. Thus, the surface area of the standard bock is 9,677 square mm while the area of expanded test bock is 10,757 square mm. This is an increase in area of only 11%. However, the increase in test sites changes from 65 to 84. This results in a 29% increase.

These formulas apply to any size indentation. For compatibility with existing manufacturing process, one could choose only one of two sides of the test block, thus, achieving only a partial benefit. The same criteria is also applicable to other shapes of test blocks, such as round ones wherein a small increase in diameter allows one more set of test sites around the circumferential edge.

Thus, the goal of producing the greatest number of test sites for a particular amount of material for the test block is met, i.e., while meeting the standards of spacing; the cost of a test block (primarily material cost) has been optimized relative to the number of test sites per block.

Although the present invention has been described with reference to certain preferred embodiments thereof, other versions are readily apparent to those of ordinary skill in the preferred embodiments contained herein.

What is claimed is:

1. A test block having a plurality of testing sites for use with a hardness testing apparatus wherein spacing requirements between testing sites are predetermined by ASTM wherein the number of test sites on said test block and expected indentation diameter is optimized using the following formula for a test block having a typical size of 2.5 inches, that is designated as A, by 6 inches that is designated as B, wherein said formula is:
ED=Edge Distance=2.5*indentation diameter from the center of indentation to the edge of said test block,
CC=Center to Center of indentation=3*indentation diameter from center of indentation to center of indentation,
NIS=Number of possible Indentation on a prior art test block,
NN=NIS+1,
DA & DB=Dimensions of said test block for one more row of indentations,
Number of 3.5 mm indentations along the short dimension (A),
NIS of A=Integer of (A−(2*ED))/CC=63.5−(2*8.7))/10.5=4,
NN of A=5,
DA=Dimension needed to fit one more row=(2*ED)+(CC*NN)=(2*8.7)+(10.5*5)=69.9,
Number of 3.5 mm indentations along the long dimension (B),
NIS of B=Integer of (B−(2*ED))/CC=152.4−(2*8.7))/10.5=12,
NN of B=13,
DB=Dimension needed to fit one more row=(2*ED)+(CC*NN)=(2*8.7)+(10.5*13)=153.9, wherein the area of said typical prior art block=63.5*152.4=9677 sq. mm, and wherein the area of said block=69.9*153.9=10757 sq. mm, such that the number of possible Indentations on prior art block=4*12=48, and such that the number of indentations on said block=5*13=65; thus said has only an 11% increase in area over the prior art block but a 35% increase in number of indentations, and wherein this formula can be scaled for any size indentation.

2. The test block of claim 1 further comprising:
means for enabling said test block to have opposing surfaces to be used for providing test surfaces having a plurality of test sites on each opposing surface.

3. The test block of claim 2 wherein said means for enabling opposing surfaces to be used for providing test surfaces having a plurality of test sites on each opposing surface further comprising a cradle to support said test block such that the side of said test block having test sites being used by the hardness testing apparatus faces an indenter in said hardness testing machine and the side of said test block not being used by said hardness testing apparatus is protected from having that opposing side receiving scratches or otherwise marred during the use of said block.

4. The test block of claim 2 wherein said means for enabling opposing surfaces to be used for proving test surfaces to have opposing surfaces having a plurality of test sites on each opposing surface further comprising a plurality of pins or legs on each said opposing surface to protect the opposing surface not having its side from being indented by said hardness testing apparatus is protected having that opposing side receiving scratches or otherwise marred during the use of said block.

5. The test block of claim 4 having a plurality of testing sites for use with a hardness testing apparatus further comprising an alignment plate having indicia imprinted thereon which correspond to testing sites on said test block.

6. The plate of claim 5 wherein said plate is transparent and has at least one hole therein corresponding to at least one pin or leg on said testing block such that said plate is aligned with said testing block and such that when said one of said test sites is under the indenter and said test site cab can be indented once said plate has been moved out of the way.
